(19) United States
(12) Patent Application Publication
(10) Pub. No.: US 2010/0328369 A1
(43) Pub. Date: Dec. 30, 2010

(54) MULTI-GRADATION DRIVE CIRCUIT, DRIVING METHOD, AND DISPLAY DEVICE OF CHOLESTERIC LIQUID CRYSTAL PANEL

(75) Inventor: Tomohisa Shingai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/879,225

(22) Filed: Sep. 10, 2010

Related U.S. Application Data
(63) Continuation of application No. PCT/JP2008/056222, filed on Mar. 28, 2008.

(51) Int. Cl. G09G 5/10

(52) U.S. Cl. 345/690

(57) ABSTRACT

A multi-gradation drive circuit that drives a cholesteric liquid crystal panel in a plurality of drive phases in different drive cycles, includes: a current upper limit control circuit that calculates an upper limit of a supply current of a liquid crystal drive power source and outputs an upper limit control signal; and a supply current limiting circuit that limits the supply current of the liquid crystal drive power source to the upper limit value or less specified by the upper limit control signal, wherein the current upper limit control circuit switches the upper limit control signal to another in accordance with the drive cycle in each drive phase.

### CROSS-REFERENCE TO RELATED APPLICATIONS

This application is a continuation application and is based upon PCT/JP2008/056222, filed on Mar. 28, 2008, the entire contents of which are incorporated herein by reference.

### FIELD

The embodiments discussed herein are related to a cholesteric liquid crystal display device, a multi-gradation drive circuit thereof, and a driving method thereof and in particular, to a technique for reducing power consumption when driving a cholesteric liquid crystal panel into multiple gradations in a plurality of drive phases in different drive cycles.

### BACKGROUND

Electronic paper using cholesteric liquid crystal has attracted attention as electronic paper capable of producing “a bright color display, a multi-gradation (full-color) display, a powerless display”. Cholesteric liquid crystal is also referred to as chiral nematic liquid crystal and is liquid crystal in which molecules of the nematic liquid crystal form a cholesteric phase by adding a comparatively large amount (tens of percents) of additives (chiral material) having the chiral properties to the nematic liquid crystal.

Display/drive principles of a display device using cholesteric liquid crystal are described in WO2005/024774A1, etc., and therefore, the content described in WO2005/024774A1 is cited and explanation of the display/drive principles is omitted here.

In a liquid crystal display using NT liquid crystal, STN liquid crystal, cholesteric liquid crystal, etc., an extremely large transient current flows only when charge/discharge start because the liquid crystal is a capacitive load. FIG. 1A and FIG. 1B are diagrams explaining this phenomenon.

As illustrated in FIG. 1A, positive and negative voltage pulses output from a drive source 1 are applied to a capacitor 3 corresponding to liquid crystal via a resistor 2. Here, e represents a pulse voltage output from the drive source 1, i a current that flows through a circuit, R a resistance value of the resistor 2, C a capacitance value of the capacitor (liquid crystal) 3, and V a voltage across both ends of the capacitor 3.

As illustrated in FIG. 1B, when the initial voltage of the capacitor (liquid crystal) 3 is 0 V and the drive source 1 outputs the voltage e that changes stepwise, the current i and the voltage V at a time t are expressed by the following mathematical expressions (1) and (2).

i=(e/R)×exp(−t/C×R)) (1)

V=e×(1−exp(−t(C×R)) (2)

As illustrated in FIG. 1B, at the rise of the voltage e, the current i rises rapidly toward e/R and drops rapidly and exponentially with a time constant C×R. The way the current i changes differs depending on the resistance value R of the resistor 2.

A liquid crystal display device has a power source part that generates a voltage to be applied to liquid crystal from a low voltage (3 V etc.) and a step-up circuit is provided within the power source part. The charge/discharge cycle of normal liquid crystal panel that displays a motion picture is as sufficiently short as about a few microseconds (μs), and therefore, the load current of the power source part is smoothed by a smoothing capacitor within the power source part and a high conversion efficiency may be obtained in the step-up circuit. On the other hand, a cholesteric liquid crystal panel that displays a still image has a charge/discharge cycle of about one millisecond (ms), which is rather long, and therefore, the load current in the power source part is hardly smoothed and there is such a problem that only low conversion efficiency may obtained in the step-up circuit.

Generally, it is known that the transient current when charge/discharge start may suppressed effectively without considerably affecting the charge/discharge time by limiting a load current upper limit value to a predetermined value when the load capacitance is constant when the capacitive load charges/discharges. FIG. 2A and FIG. 2B are diagrams for explaining this phenomenon.

A circuit illustrated in FIG. 2A has a configuration in which a current limiting circuit 4 is provided in the circuit in FIG. 1A.

For example, as illustrated in FIG. 2B, when the current i is limited to ½ of the maximum value e/R, the current rapidly reaches e/(2×R) at the rise of the voltage e. The voltage V begins to rise rectilinearly as expressed by the following mathematical expression (3).

V=(e×t/(2×R))/C (3)

When the voltage V reaches e/2, the voltage to be applied to the resistor 2 afterward falls below e/2 and the current i falls below e/(2×R), and therefore, the current limitation is removed. If the time when the voltage V reaches e/2 is assumed to be t0, the capacitor 3 is charged to a voltage higher than e/2 at t0 when there is no current limitation, and therefore, the current i afterward is smaller than that when there is a current limitation and the increase rate of the voltage V is also smaller than that when there is a current limitation. When there is a current limitation, the current i drops rapidly and exponentially with a time constant C×R. As may be seen from FIG. 2B, it is possible to effectively suppress the peak of the transient current without considerably affecting the charge/discharge time by appropriately setting the current upper limit value.

In FIG. 2A, the load capacitance is constant, however, in driving a cholesteric liquid crystal display panel, the load capacitance is not constant but varies depending on an image to be displayed. The inventors have described in WO2005/024774A1 that it is possible to effectively suppress the transient current when the charge/discharge start even in such a case by limiting the load current to a constant value and to considerably improve the operational stability of the display panel drive control circuit.

On the other hand, WO2006/103738A1 describes a multi-gradation driving method of a cholesteric liquid crystal panel. FIGS. 3A to 3C are diagrams for explaining the multi-gradation driving method and FIG. 3A illustrates a completed pattern including four gradation areas from level 0 to level 3. The multi-gradation driving method has step 1 for setting two states, i.e., a non-reflection state (focal conic state) corresponding to the lowest level (level 0) and a reflection state (planar state) corresponding to the highest level (level 3) and step 2 for setting a state corresponding to an intermediate gradation (state where the focal conic state and the planar state exist mixedly). Step 2 has a plurality of sub steps in accordance with the number of intermediate gradation levels. In the case of the four gradation levels illustrated in FIG. 3A, the intermediate gradation has two levels, and therefore, step 2 has sub step 1 and sub step 2.

First, in step 1, as illustrated in FIG. 3B, the area of level 0 is driven into the focal conic state and the areas of levels 1 to 3 other than level 0 is driven into the planar state. Next, in sub step 1, as illustrated in FIG. 3C, a pulse is applied so that the areas to be driven into level 1 and level 2 of the areas having been driven into the planar state are driven into the focal conic state. The pulse period and the pulse voltage of the pulse are set so that part of the planar state is changed into the focal conic state and the mixture ratio between the focal conic state and the planar state is a ratio corresponding to level 2. Further, in sub step 2, a pulse is applied to the area to be driven into level 1 of the areas having been driven into the state where the focal conic state and the planar state exist mixedly so that the mixture ratio of the focal conic state becomes higher. The pulse period and the pulse voltage of the pulse are set so that the state where the mixture ratio between the focal conic state and the planar state is a ratio corresponding to level 2 is brought into the state where the mixture ratio is a ratio corresponding to level 1. In this manner, in step 1, the cholesteric liquid crystal panel is driven into the focal conic state and the planar state in step 1 and then in step 2, the cholesteric liquid crystal panel is driven so that the mixture ratio of the focal conic state in the partial area in the planar state is gradually increased, and thus, high evenness (low granularity properties), large number of gradations, high black concentration, and high contrast may be obtained and there is also an advantage that crosstalk may be avoided. The driving method in each step is further explained.

FIG. 4 is a diagram illustrating pulse waveforms to be applied to each pixel in step 1 and in step 2. As illustrated schematically, in step 1, a pulse at ON level (±32 V) is applied to a pixel to be brought into the reflection state to drive the pixel into the planar state and a pulse at OFF level (±24 V) is applied t a pixel to be brought into the non-reflection state to drive the pixel into the focal conic state. The drive speed is 7 ms/line, i.e., the pulse period is 7 ms.

In step 2, scanning is performed at speed higher than in step 1. That is, by applying a pulse with a short pulse period, part of the planar state is changed into the focal conic state. In step 2, as illustrated in FIG. 4, a pulse at ON level (±24 V) is applied to a pixel the reflectance of which is to be reduced to change part of the planar state into the focal conic state and a pulse at OFF level (±12 V) is applied to a pixel the reflectance of which is to be maintained. The pulse period in step 2 differs between in sub step 1 and in sub step 2, that is, 3 ms in sub step 1 and 1 ms in sub step 2.

As described above, in the above-mentioned multi-gradation driving method of a cholesteric liquid crystal panel, pulses with pulse periods about ten times different are applied, and therefore, the charge/discharge cycle also changes accordingly.

The above-mentioned multi-gradation driving method of a cholesteric liquid crystal panel is described in detail in WO2006/103738A1, and therefore, no more explanation is given here.

Various methods have been proposed for the multi-gradation driving method of a cholesteric liquid crystal panel, not limited to the driving method described in WO2006/103738A1, and in particular, from the standpoint of the reduction in power consumption, a PWM driving method is suitable, in which pulses with different pulse widths are combined and applied. In the PWM driving method, pulses with different pulse widths (periods) are applied, and therefore, the charge/discharge cycle will also vary accordingly as in the multi-gradation driving method described in WO2006/103738A1.

Related Documents

WO2005/024774A1

WO2006/103738A1

### SUMMARY

According to a first aspect of the embodiments, a multi-gradation drive circuit that drives a cholesteric liquid crystal panel in a plurality of drive phases in different drive cycles, includes: a current upper limit control circuit that calculates an upper limit of a supply current of a liquid crystal drive power source and outputs an upper limit control signal; and a supply current limiting circuit that limits the supply current of the liquid crystal drive power source to the upper limit value or less specified by the upper limit control signal, wherein the current upper limit control circuit switches the upper limit control signal to another in accordance with the drive cycle in each drive phase.

According to a second aspect of the embodiments, a cholesteric liquid crystal display device includes: a cholesteric liquid crystal panel; and a multi-gradation drive circuit that drives the cholesteric liquid crystal panel in a plurality of drive phases in different drive cycles, wherein the multi-gradation drive circuit includes: a current upper limit control circuit that calculates an upper limit of a supply current of a liquid crystal drive power source and outputs an upper limit control signal; and a supply current limiting circuit that limits the supply current of the liquid crystal drive power source to the upper limit value or less specified by the upper limit control signal, wherein the current upper limit control circuit switches the upper limit control signal to another in accordance with the drive cycle in each drive phase.

According to a third aspect of the embodiments, a multi-gradation driving method of driving a cholesteric liquid crystal display panel in a plurality of drive phases in different cycles, the method includes: calculating an upper limit value of a supply current of a power source for driving liquid crystal; and switching the upper limit value of the supply current of the power source for driving liquid crystal to another in accordance with the drive cycle in each drive phase.

The object and advantages of the embodiments will be realized and attained by means of the elements and combination particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a diagram illustrating a liquid crystal drive circuit;

FIG. 1B is a diagram for explaining a dull of a drive waveform by a liquid crystal capacitor;

FIG. 2A is diagram illustrating a liquid crystal drive circuit having a current limiting circuit;

FIG. 2B is a diagram for explaining a dull of a drive waveform by the drive circuit in FIG. 2A;

FIGS. 3A to 3C are diagrams for explaining a multi-gradation driving method of a cholesteric liquid crystal panel described in WO2006/103738A1;

FIG. 4 is a diagram explaining an example of a drive waveform in the multi-gradation driving method of a cholesteric liquid crystal panel described in WO2006/103738A1;

FIG. 5 is a diagram for explaining a problem of the current limitation in a multi-gradation driving method of a cholesteric liquid crystal panel;

FIG. 6 is a diagram for explaining a method of limiting a current in a multi-gradation driving method of a cholesteric liquid crystal panel in an embodiment;

FIG. 7 is a schematic configuration diagram of a cholesteric liquid crystal display device in a first embodiment;

FIG. 8 is a diagram illustrating a configuration of a regulator of the cholesteric liquid crystal display device in the first embodiment;

FIG. 9 is a diagram illustrating a configuration of a current upper limit control circuit of the cholesteric liquid crystal display device in the first embodiment;

FIG. 10 is a time chart illustrating a driving method of the cholesteric liquid crystal display device in the first embodiment;

FIG. 11 is a diagram illustrating a configuration of a modified example of a regulator;

FIG. 12 is a diagram illustrating a configuration of another modified example of a regulator;

FIG. 13 is a diagram illustrating a configuration example of a current limiting circuit configured by separate components when configuring a regulator in combination with a general operational amplifier without using an operational amplifier with a current limit function; and

FIG. 14 is a schematic configuration diagram of a cholesteric liquid crystal display device in a second embodiment.

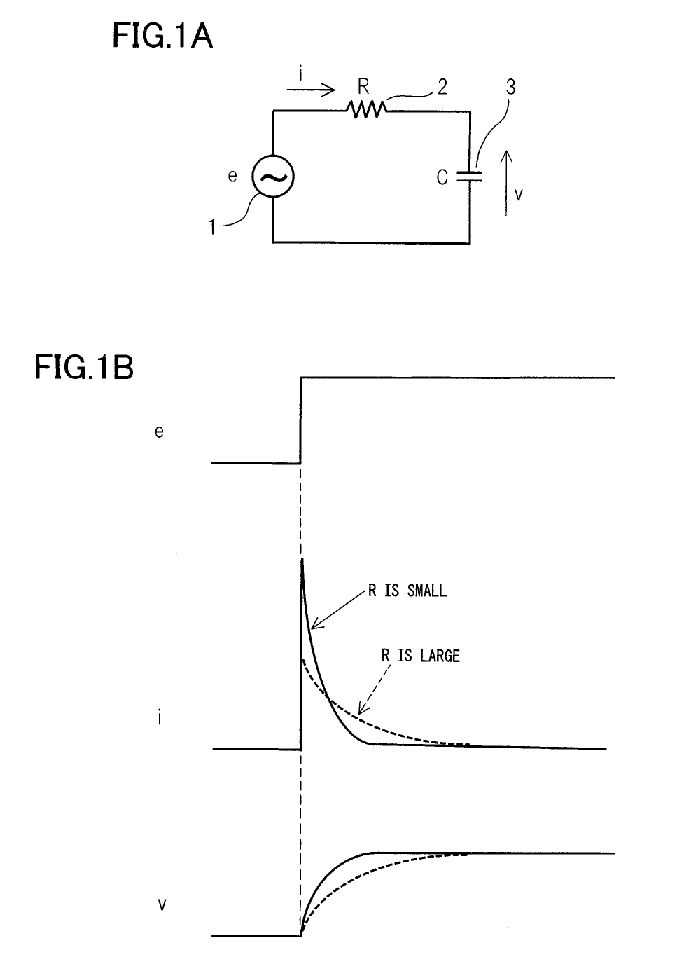

### DESCRIPTION OF EMBODIMENTS

Before describing embodiments, problems occurring when a cholesteric liquid crystal panel is driven by the above-mentioned conventional multi-gradation driving method are explained.

As described above, when a cholesteric liquid crystal panel is driven by the multi-gradation driving method, the charge/discharge cycle varies generally, and the range of the change is about ten times. In this case, when the load current is limited to a fixed value, the sharp peak of the transient current may be relaxed to a value about twice the average current in the shortest charge/discharge cycle. However, the peak becomes by far larger than the average current in other charge/discharge cycles, about ten times.

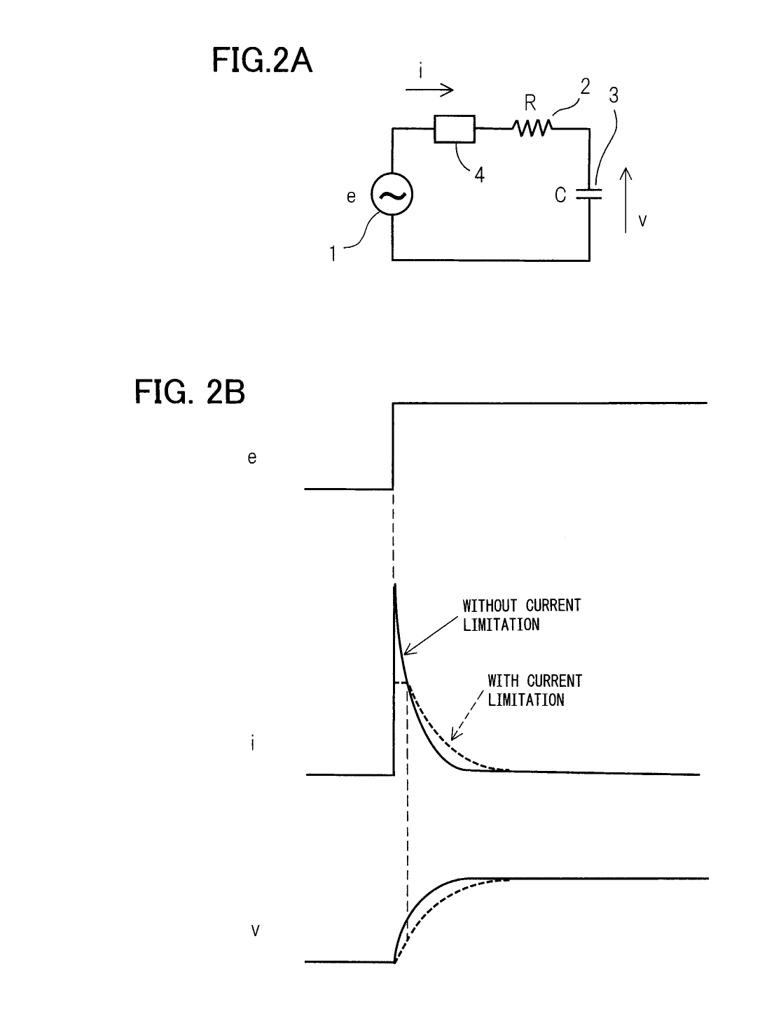

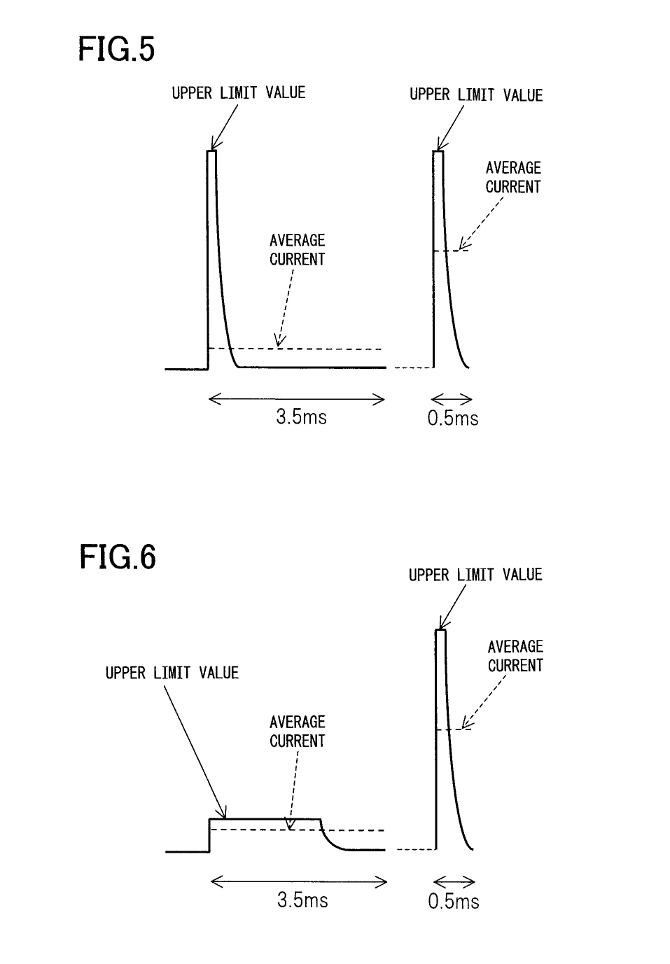

FIG. 5 is a diagram for explaining this problem. A case where the current is limited is considered, as illustrated in FIG. 2B. When the charge/discharge cycle is 3.5 ms, the current rises rapidly up to the current limit value as illustrated schematically and after the state where the current is the current limit value is maintained, the current drops to about zero in about 0.5 ms. The charge/discharge cycle is 3.5 ms, and therefore, the average current in the cycle is by far smaller than the current limit value as illustrated schematically. In other words, the current limit value is by far larger than the average current, about ten times. In contrast to this, when the charge/discharge cycle is 0.5 ms, the current changes in the same manner as described above, however, the charge/discharge cycle is 0.5 ms, and therefore, the average current in the cycle is a level comparatively close to the current limit value as illustrated schematically. In other words, the current limit value is slightly larger than (about twice) the average current.

When the cholesteric liquid crystal panel is driven by the multi-gradation driving method and the current limit value is limited to a value twice the average current in the shortest charge/discharge cycle of 1 ms, the current limit value, i.e., the current peak is 14 times the average current in the longest charge/discharge cycle of 7 ms.

As described above, when the cholesteric liquid crystal panel is driven by the multi-gradation driving method, the load current varies largely and there is such a problem that only low conversion efficiency may be obtained in the step-up circuit.

Embodiments explained below realize a novel multi-gradation drive circuit, a driving method, and a display device of a cholesteric liquid crystal panel capable of effectively relaxing the variation in load current (ratio between peak current and average current) even if the charge/discharge cycle changes considerably when driving a cholesteric liquid crystal panel.

Preferred embodiments of the present invention will be explained with reference to accompanying drawings.

First, the principles of the driving method of a cholesteric liquid crystal panel in the embodiments are explained with reference to FIG. 6. In the driving method, in a plurality of charges/discharges in different cycles, the current upper limit value of a step-up circuit of a power source part is limited to a predetermined value calculated in accordance with the charge/discharge cycle. As illustrated in FIG. 6, the average current in a cycle of 3.5 ms is by far smaller than the average current in a cycle of 0.5 ms (for example, about 1/7). The ratio between the current upper limit value in a cycle of 3.5 ms and the current upper limit value in a cycle of 0.5 ms is made equal to the ratio between the average current in a cycle of 3.5 ms and the average current in a cycle of 0.5 ms. Due to this, regardless of the charge/discharge cycle, it is possible to relax the transient current to a predetermined coefficient times (for example, twice) the average current.

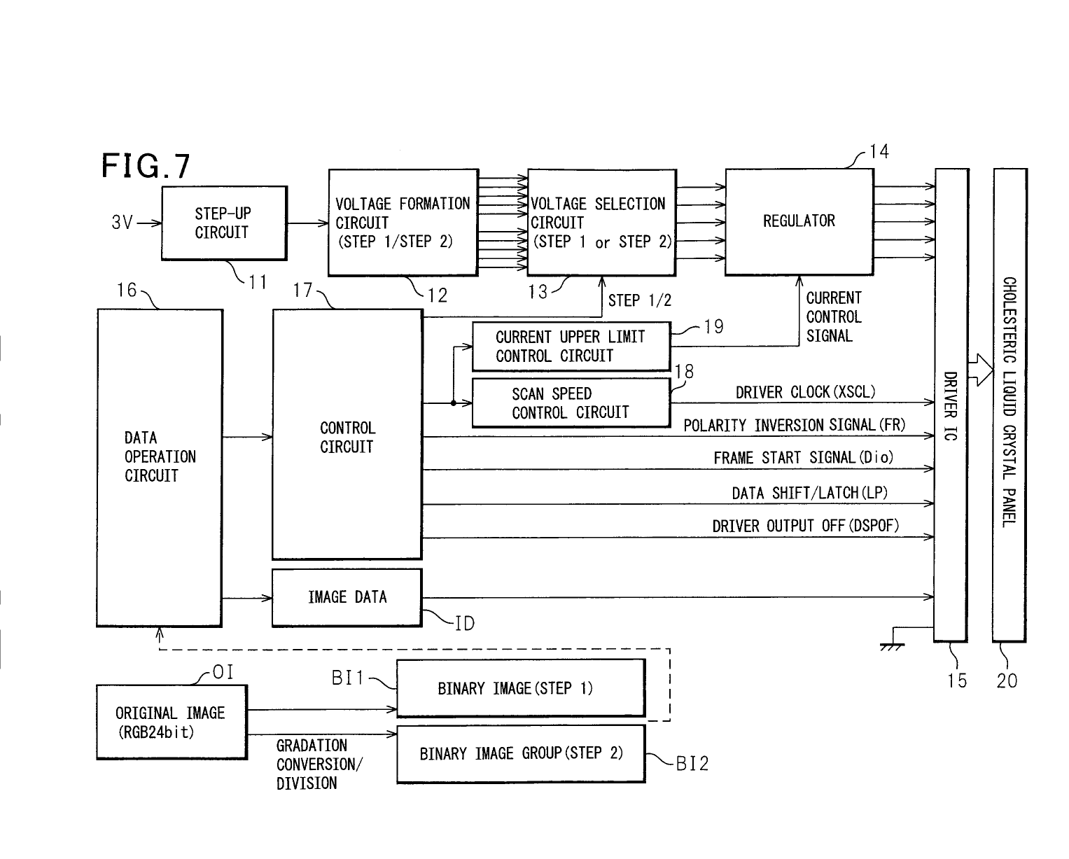

FIG. 7 is a diagram illustrating a schematic configuration of a cholesteric liquid crystal display device in a first embodiment having a multi-gradation drive circuit that drives a cholesteric liquid crystal panel in a plurality of drive phases in different drive cycles.

As illustrated in FIG. 7, the cholesteric liquid crystal display device in the first embodiment has a step-up circuit 11 that generates a voltage of about 40 V from a power source voltage of 3 to 5 V, a voltage formation circuit 12 that forms various voltages to be supplied to a driver IC, a voltage selection circuit 13 that selects a voltage to be used in accordance with a drive phase from among a plurality of voltages supplied from the voltage formation circuit 12, a regulator 14 that stabilizes and outputs a voltage output from the voltage selection circuit 13, a driver IC 15, a data operation circuit 16 that develops and outputs image data processed for a liquid crystal display into a form to be supplied to the driver IC 15, a control circuit 17 that controls each part, a scan speed control circuit 18 that varies a scan speed in accordance with the cycle of a drive phase, a current upper limit control circuit 19, and a cholesteric liquid crystal panel 20 to which a drive signal is applied from the driver IC 15.

In the first embodiment, the multi-gradation driving method described in WO2006/103738A1 is used. However, the first embodiment is not limited to this and any drive method having a plurality of drive phases in different drive cycles may be accepted. An original image OI includes RGB data (3×8=24 bits), each of R, G, and B data being 8-bit data. In the first embodiment, the RGB data is subjected to the error diffusion processing and the higher four to six bits are used. From the original image OI, a binary image (step 1) BI1 indicative of pixels to be brought into the focal conic state and pixels to be brought into the planar state in step 1 and a binary image group (step 2) BI2 indicative of pixels the state of which is changed in each sub step in step 2 are generated. BI1 and BI2 are sent to the data operation circuit 16 as processed image data. The image processing is performed by a computer. The computer may also be used as a computer constituting the data operation circuit 16 and/or the control circuit 17.

The driver IC 15 includes a scan driver and a data driver and is realized by a general-purpose driver IC.

The data operation circuit 16 generates image data ID for a display and various pieces of control data from the image data BI1 for step 1 and the image data BI2 for step 2 and outputs the various pieces of control data to the control circuit 17 and the image data ID for a display to the driver IC 15.

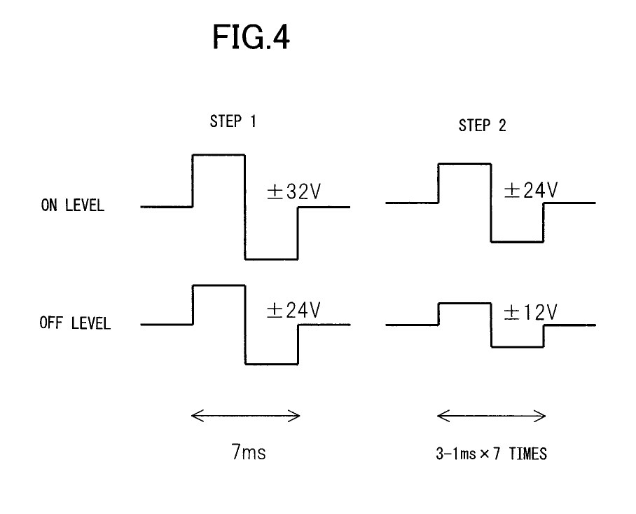

The control circuit 17 outputs a signal indicative whether the drive phase to be executed is step 1 or step 2 to the voltage selection circuit 13. The voltage selection circuit 13 selects a voltage in accordance with the signal. The control circuit 17 outputs a data shift/latch signal LP, a polarity inversion signal FR, a frame start signal Dio, and a driver output OFF signal DSPOF to the driver IC. The data shift/latch signal LP is a signal that controls to shift a scan line to the next line and to latch a data signal. The driver IC latches image data ID shifted internally in synchronization with the signal LP. The polarity inversion signal FR is a signal indicative of a term during which a pulse as illustrated in FIG. 4 has the positive polarity and a term during which the pulse has the negative polarity. The driver IC 15 inverts the polarity of an output voltage in accordance with the polarity inversion signal FR. The frame start signal Dio is a synchronous signal when a display screen corresponding to one whole screen is drawn. The driver output OFF signal DSPOF is a signal to forcedly reduce all of the output voltages of the driver IC 15 to zero.

The control circuit 17 outputs a reference clock to the scan speed control circuit 18 and the scan speed control circuit 18 generates a driver clock XSCL from the reference clock in accordance with a scan cycle and outputs the driver clock XSCL to the driver IC 15. The driver IC 15 takes in the image data ID supplied from outside in synchronization with the driver clock XSCL and shifts the image data ID therein.

The current upper limit control circuit 19 receives the reference clock from the control circuit 17 and calculates a current upper limit value in accordance with a scan cycle and outputs the value to the regulator. The regulator 14 limits a current to be output to the specified current upper limit value or less.

The components, except for the current upper limit control circuit 19 and the regulator 14 in the above-mentioned configuration in the first embodiment are the same as those of the conventional example, and therefore, no more explanation will be given. With the conventional display device in which the upper limit value of the current is set, the current upper limit value of the regulator 14 is fixed. However, the first embodiment differs from the conventional example in that the regulator 14 is configured to be capable of varying the current upper limit value and to set the current upper limit value to that specified by the current upper limit control circuit 19.

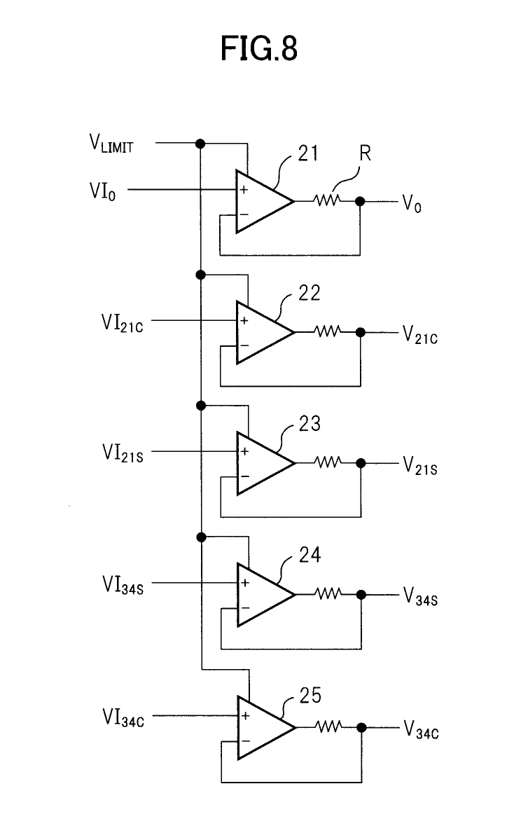

FIG. 8 is a diagram illustrating a configuration of the regulator 14. Five outputs of the voltage selection circuit 13 are represented as VI₀, VI_{21C}, VI_{21S}, VI_{34S}, and VI_{34C}, respectively, the current upper limit value from the current upper limit control circuit as V_{LIMIT}, and outputs of the regulator 14 to the driver IC 15 as V₀, V_{21C}, V_{21S}, V_{34S}, and V_{34C}, respectively. As illustrated in FIG. 8, the regulator 14 has five stabilization circuits, each of which stabilizes and outputs each input voltage. Each stabilization circuit is a voltage follower circuit configured by using operational amplifiers 21 to 25 having a current limit function and the current upper limit value V_{LIMIT} is input to the current limit value terminal of the operational amplifier. The operational amplifiers 21 to 25 having a current limit function are realized by, for example, LT1970 (brand name) manufactured by Linear Technology, Corp. The current upper limit value V_{LIMIT} sets an upper limit value of a current by an analog voltage value and when the current upper limit value V_{LIMIT} is 5 V, the current upper limit value is 10 mA and when the current upper limit value V_{LIMIT} is 0.5 V, the current upper limit value is 1 mA.

The operational amplifier component having a current limit function and a circuit that uses the same are widely known, and therefore, no more explanation is given.

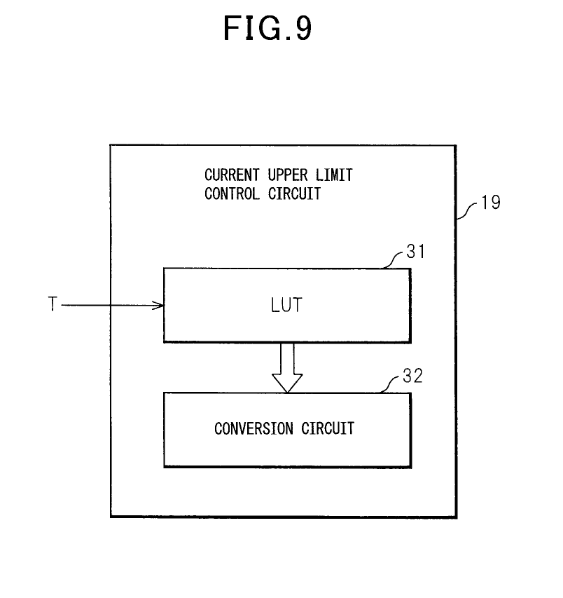

FIG. 9 is a diagram illustrating a configuration of the current upper limit control circuit 19. As illustrated in FIG. 9, the current upper limit control circuit 19 has a lookup table 31 that stores upper limit value data in advance of a supply current corresponding to a drive cycle T (driver clock) with the drive cycle T as an address, and a conversion circuit 32 that converts the upper limit value data read from the lookup table 31 into the current upper limit control signal (V_{LIMIT}) to be supplied to the regulator 14. The conversion circuit 32 may be realized by, for example, a D/A converter. The drive cycle T is received from the control circuit 17 or the scan speed control circuit 18, however, it is also possible to calculate the drive cycle T in the current upper limit control circuit 19 based on a signal sent from the control circuit 17.

The upper limit value Imax of the supply current stored in the lookup table 31 is determined by the following expression when the drive cycle is T, the output voltage in the drive cycle T is V, and the average load capacitance for the output voltage V in the drive cycle T is C.

Imax=α×C×V/T

Here, C×V/T represents the average current lave.

The above-mentioned α is a coefficient that represents a ratio of the upper limit value of the load current to the average current and a value at least not less than 1, or a value not less than 1.5 and not more than 5, and for example, about 2 desirably. The more closer to 1 the coefficient α is, the more efficient the step-up circuit is, however, the change in voltage to be applied becomes more gradual. Because of this, it is desirable to vary α for each drive phase and to set the coefficient α to a large value when a steeper change is necessary depending on the drive phase.

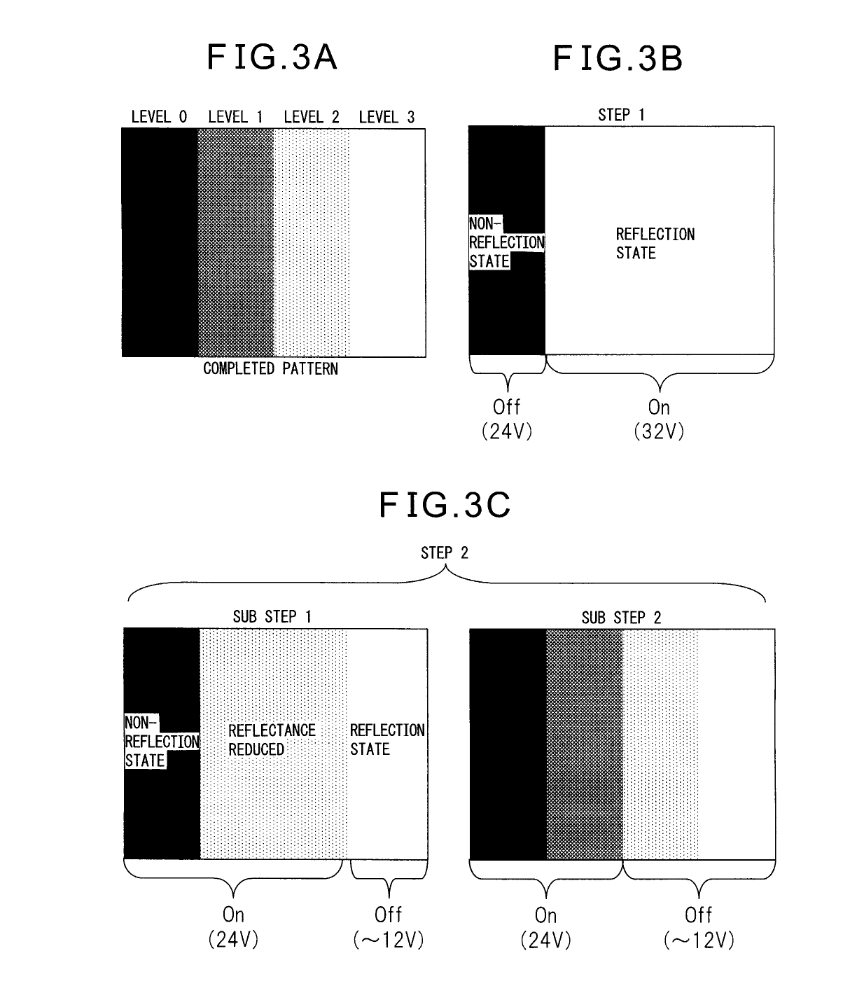

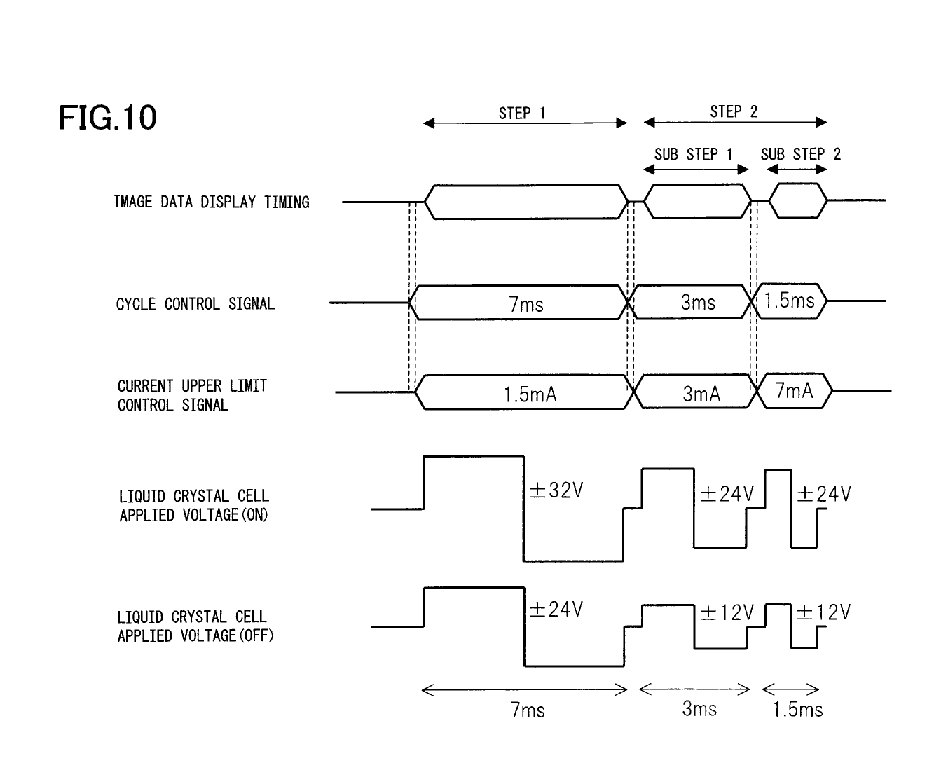

FIG. 10 is a time chart illustrating a driving method of a cholesteric liquid crystal display device in a first embodiment. The cholesteric liquid crystal display device in the first embodiment uses the multi-gradation driving method described in WO2006/103738A1, which is explained with reference to FIG. 3 and FIG. 4.

As illustrated in FIG. 10, the drive sequence has step 1 and step 2 and step 2 further has sub step 1 and sub step 2.

In step 1, the cycle control signal (driver clock XSCL) is ON for 7 ms and while the cycle control signal is ON, the image data display timing is ON and image data is supplied. The liquid crystal cell applied voltage is a pulse having a voltage of ±32 V in the ON cell and having a voltage of ±24 V in the OFF cell. Consequently, the positive polarity phase and the negative polarity phase are about 3.5 ms, respectively. The current upper limit control signal limits the supply current to 1.5 mA.

In sub step 1, the cycle control signal (driver clock XSCL) is ON for 3 ms and while the cycle control signal is ON, the image data display timing is ON and image data is supplied. The liquid crystal cell applied voltage is a pulse having a voltage of ±24 V in the ON cell and having a voltage of ±32 V in the OFF cell. Consequently, the positive polarity phase and the negative polarity phase are about 3 ms, respectively.

In sub step 2, the cycle control signal (driver clock XSCL) is ON for 1.5 ms and while the cycle control signal is ON, the image data display timing is ON and image data is supplied. The liquid crystal cell applied voltage is a pulse having a voltage of ±24 V in the ON cell and having a voltage of ±12 V in the OFF cell. Consequently, the positive polarity phase and the negative polarity phase are about 7 ms, respectively. As described above, in the first embodiment, the upper limit current value in each step is controlled so as to be inversely proportional to the drive cycle in each step.

The current upper limit control circuit 19 reads data indicative of the upper limit current value from the lookup table 31 in accordance with the drive cycle of the step to be executed next and outputs a voltage value corresponding to the data read by the conversion circuit 32. After the voltage value is fixed, image data is supplied and the cycle control signal and the image data display timing signal turn ON.

As described above, in the first embodiment, the multi-gradation driving method described in WO2006/103738A1 is used, however, the first embodiment is not limited to this but is applied to a driving method having a plurality of drive phases in different drive cycles to limit the current in accordance with the drive cycle.

As above, the cholesteric liquid crystal display device in the first embodiment is explained and the rest of the configuration except for that explained above is the same as that in the conventional example.

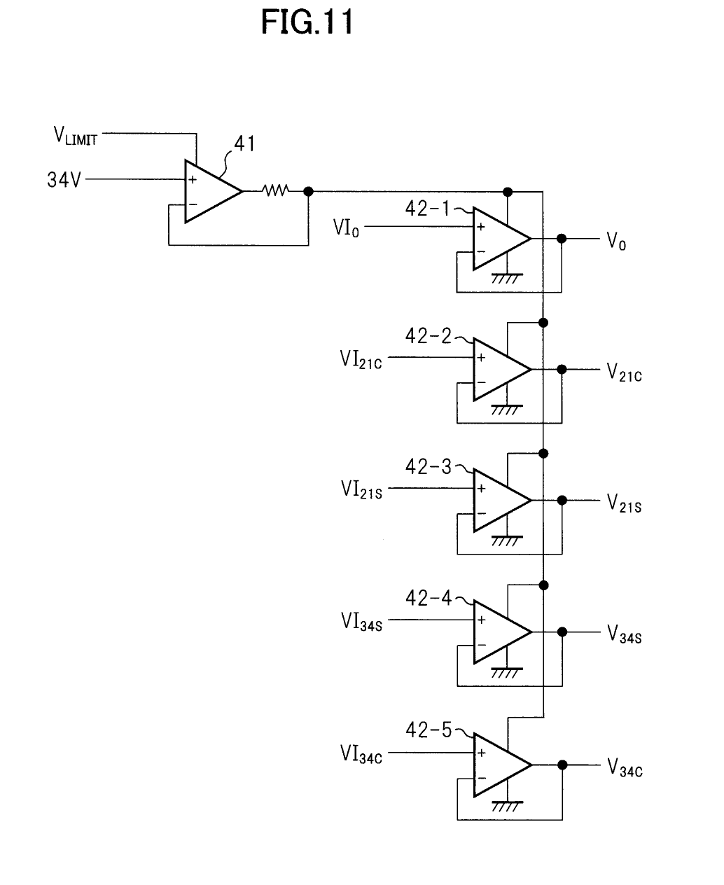

FIG. 11 is a diagram illustrating a configuration of a modified example of the regulator 14 of the cholesteric liquid crystal display device in the first embodiment. In the first embodiment, for the five outputs of the voltage selection circuit 13, the five voltage follower circuits with a current limit function are provided, however, in this modified example, only one operational amplifier with a current limit function is used.

As illustrated in FIG. 11, in this modified example, the five voltage follower circuits stabilized with the five outputs VI₀, VI_{21C}, VI_{21S}, VI_{34S}, and VI_{34C}, respectively, of the voltage selection circuit 13 are configured by general operational amplifies 42-1, 42-2, 42-3, 42-4, and 42-5. Then, the output of the power source current limiting circuit configured by an operational amplifier 41 with a current limit function is connected to the power source of each voltage follower circuit and thus the power source current of each voltage follower circuit is limited. Due to this, it is possible to limit the output currents corresponding to the five outputs VI₀, VI_{21C}, VI_{21S}, VI_{34S}, and VI_{34C} of the voltage selection circuit 13 as in the first embodiment. In the circuit in FIG. 11, it is not necessary to use an operational amplifier with a current limit function as the operational amplifier constituting the five voltage follower circuits, and therefore, the degree of freedom in selecting an operational amplifier is increased and the reduction in cost may be accomplished. As an operational amplifier without a current limit function, for example, MC33171/2/4 manufactured by Motorola, Inc. or LT1490/1 manufactured by Liner Technology, Corp. is used.

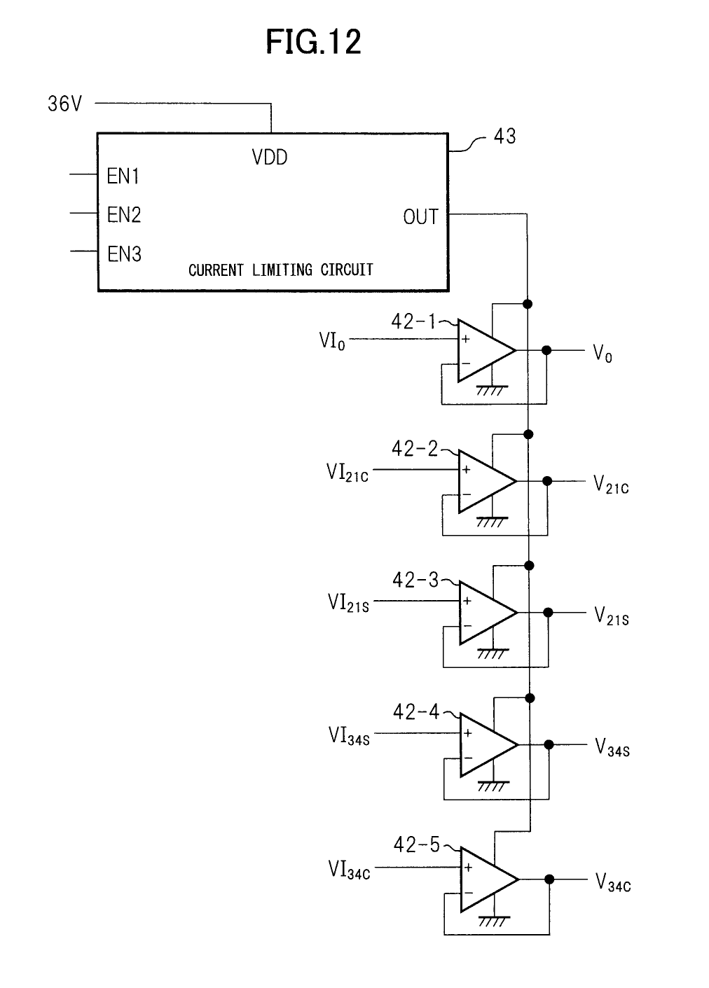

FIG. 12 is a diagram illustrating a configuration of still another modified example of the regulator 14. This modified example has a configuration similar to that in the eleventh modified example but different in that the power source current limiting circuit that commonly limits the current value of the five voltage follower circuits configured by the general operational amplifiers 42-1, 42-2, 42-3, 42-4, and 42-5 is replaced with a current limiting circuit 43 configured by separate components without using an operational amplifier with a current limit function.

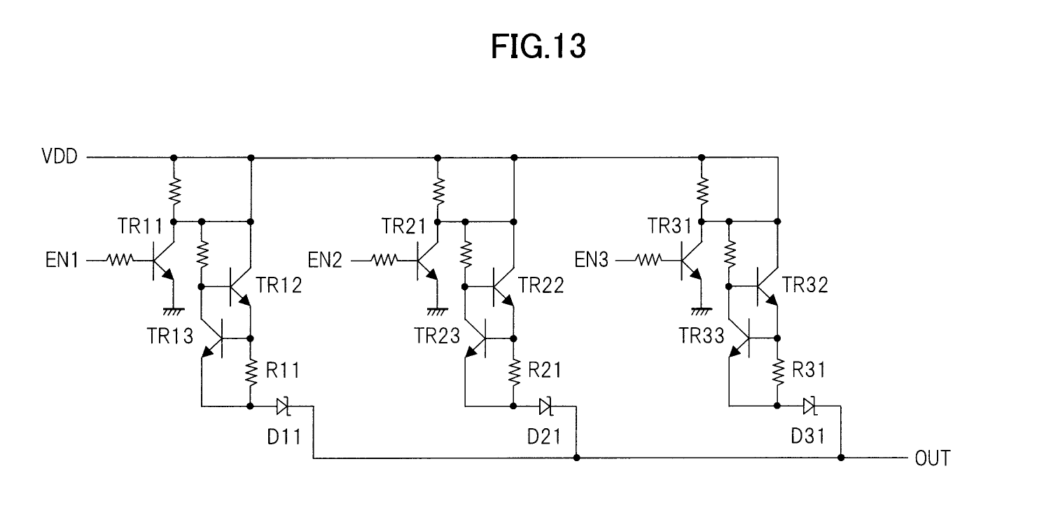

FIG. 13 is a diagram illustrating a configuration example of a current limiting circuit configured by separate components. In FIG. 13, VDD represents an operational amplifier power source and it is set by taking into consideration the drop in voltage (about 1.3 V) of the current limiting circuit itself. In the following explanation, it is assumed that i, j take any of 1, 2, 3. In the figure, a circuit part including TRi2 and TRi3 is a general, widely-known current limiting circuit and the current upper limit value may be controlled by the value of Ri1. A current upper limit value Ii-max is given by the following expression.

Ii-max=0.6/Ri1

Three of such current limiting circuits are connected in parallel.

Only one of logic signals ENi is turned to “Low (L)” and the others to “High (H)”. The current supplied to the voltage follower circuit including an operation amplifier is limited to Ij-max when only ENj is L. Di1 represents a Schottky barrier diode to prevent interference between current limiting circuits.

The current upper limit control circuit 19 stores selection data indicating which current limiting circuit is selected in correspondence with the drive cycle T in the LUT 31. The conversion circuit 32 is realized by a decoder that decodes the selection data.

The first embodiment is explained as above. For example, with a trial product that drives an A4-sized color cholesteric liquid crystal panel (the cell gap of each color liquid crystal layers of red, green, and blue is 5 μm and the pulse voltage is ±36 V) to which the configuration in the first embodiment is applied, the average step-up efficiency is less than 50% without a limitation of current. However, when double the average current is taken as the current limiting value as in the present embodiment, the average step-up efficiency is improved to 85%. The components used in this trial product is LM2733Y manufactured by National Semiconductor Corporation for the output of 36 V of the step-up circuit 11, MAX 8574 manufactured by MAXIM (Integrated Products) for the output of 20 V, and LT1790 made of Linear Technology, Corp. for the operational amplifiers 21 to 25 with a current limit function.

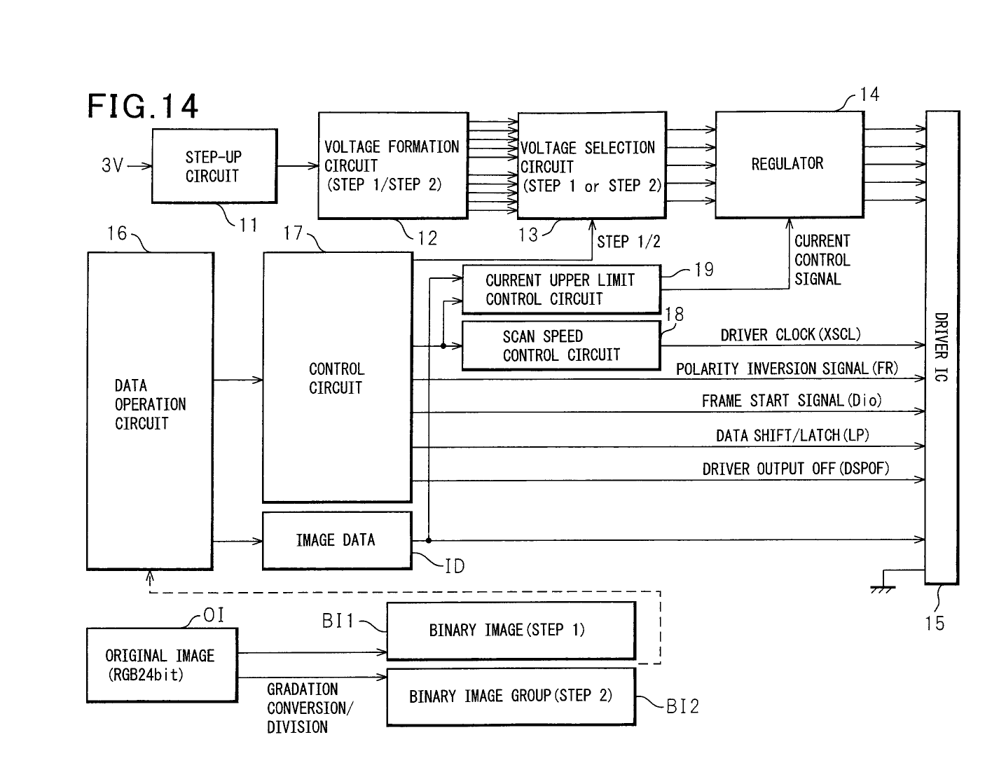

FIG. 14 is a diagram illustrating a schematic configuration of a cholesteric liquid crystal display device in a second embodiment having a multi-gradation drive circuit that drives a cholesteric liquid crystal panel in a plurality of drive phases in different drive cycles. The cholesteric liquid crystal display device in the second embodiment differs from the first embodiment in that the current upper limit control circuit 19 determines the current upper limit value from the actual load capacitance in accordance with the content of the image data ID as well as the drive cycle T and others are the same. Because of this, the current upper limit control circuit 19 not only receives data of the drive cycle from the control circuit 17 but also takes in the image data ID.

The current upper limit control circuit 19 calculates the current upper limit value Imax according to the following expression.

Imax=α×Ce×V/T

Here, α is a coefficient representing a ratio of the upper limit value of the load current to the average current, T the drive cycle, V the output voltage in the drive cycle T, and Ce the actual load capacitance in the drive line for the output voltage V in the drive cycle T.

α, T, and V are the same as those in the first embodiment.

The load capacitance of liquid crystal differs depending on the ratio of pixels to be turned ON, and therefore, the current upper limit control circuit 19 calculates the number of ON/OFF dots in each step of the image data ID. The current upper limit control circuit 19 has a lookup table that stores a relationship of the actual load capacitance corresponding to the number of ON/OFF dots calculated in advance and finds an actual load capacitance corresponding to the calculated number of ON/OFF dots. Then, the current upper limit control circuit 19 calculates Imax according to the above-mentioned expression.

Other parts are the same as those in the first embodiment.

In the second embodiment, it is also possible to improve the average step-up efficiency as in the first embodiment.

As described above, in the multi-gradation drive circuit, the driving method, and the display device of a cholesteric liquid crystal panel, the cholesteric liquid crystal display panel is driven in a plurality of drive phases in difference drive cycles, the supply current of the power source part is limited to an upper limit value or less, and the upper limit value is switched to another in accordance with the drive cycle in each drive phase according to the length of the charge/discharge cycle.

Due to this, regardless of the charge/discharge cycle, it is possible to relax the transient current peak to about twice the average current in the cycle and to considerably improve the conversion efficiency of the step-up circuit.

The driving method having a plurality of drive phases in different drive cycles includes various types in addition to the driving method described in WO2006/103738A1 and the configuration in which the upper limit value is switched to another in accordance with the drive cycle in each drive phase according to the length of the charge/discharge cycle is effective in either case.

The upper limit value of the supply current is, for example, the average current in each drive phase multiplied by a predetermined coefficient, and the predetermined coefficient is a value not less than 1.5 and not more than 5, and in particular, the value is about 2 desirably.

The average current is expressed by Iave=C×V/T where T is the drive cycle in each drive phase, lave is the average current, V is the output voltage in the drive cycle T, and C is the average load capacitance for the output voltage V in the drive cycle T.

The current upper limit control circuit that controls the current upper limit is configured to include a table that stores the upper limit value data of the supply current in advance that corresponds to the drive cycle with the drive cycle as an address and a signal conversion circuit that converts the upper limit value data read from the table into a signal to be supplied to the supply current limiting circuit. The signal conversion circuit may be realized by a D/A converter.

The supply current limiting circuit may be realized by an operational amplifier having an output current limit function. Further, the supply current limiting circuit may be configured by a plurality of current limiting circuits connected in parallel via diodes and the current upper limit value of which is fixed, and a decoder that selects a circuit to be brought into the operating state from among the plurality of current limiting circuits in accordance with a signal from the current upper limit control circuit.

The load capacitance of liquid crystal is not fixed but differs depending on the ratio of pixels to be turned ON, and therefore, it may also be possible to further provide a circuit that calculates an actual load capacitance for the output voltage V in the drive cycle T in each drive phase and set the upper limit value of the supply current to the average current lave in each drive phase multiplied by a predetermined coefficient and the average current lave to Iave=C×V/T. The actual load capacitance calculating circuit is configured to have an ON-pixel number calculating circuit that calculates the number of ON-pixels in data of an image to be displayed and a table that stores an actual load capacitance corresponding to the calculated number of ON-pixels.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A multi-gradation drive circuit that drives a cholesteric liquid crystal panel in a plurality of drive phases in different drive cycles, comprising:
a current upper limit control circuit configured to calculate an upper limit of a supply current of a liquid crystal drive power source and outputs an upper limit control signal; and
a supply current limiting circuit configured to limit the supply current of the liquid crystal drive power source to the upper limit value or less specified by the upper limit control signal, wherein
the current upper limit control circuit switches the upper limit control signal to another in accordance with the drive cycle in each drive phase.

2. The multi-gradation drive circuit according to claim 1, wherein the upper limit value of the supply current is the average current in each drive phase multiplied by a predetermined coefficient.

3. The multi-gradation drive circuit according to claim 2, wherein
the predetermined coefficient is a value not less than 1.5 and not more than 5.

4. The multi-gradation drive circuit according to claim 3, wherein
the predetermined coefficient is 2.

5. The multi-gradation drive circuit according to claim 2, wherein
the average current is given by Iave=C×V/T where T is the drive cycle in each drive phase, lave is the average current, V is the output voltage in the drive cycle T, and C is the average load capacitance for the output voltage V in the drive cycle T.

6. The multi-gradation drive circuit according to claim 1, wherein
the current upper limit control circuit comprises:
a table that stores upper limit value data in advance of the supply current corresponding to the drive cycle with the drive cycle as an address; and
a signal conversion circuit that converts the upper limit value read from the table into a signal to be supplied to the supply current limiting circuit.

7. The multi-gradation drive circuit according to claim 6, wherein
the signal conversion circuit is a D/A converter.

8. The multi-gradation drive circuit according to claim 1, wherein
the supply current limiting circuit is an operational amplifier having an output current limit function.

9. The multi-gradation drive circuit according to claim 1, wherein
the supply current limiting circuit comprises:
a plurality of current limiting circuits connected in parallel via diodes and the current upper limit value of which is fixed; and
a decoder that selects a circuit to be brought into an operating state from among the plurality of current limiting circuits in accordance with a signal from the current upper limit control circuit.

10. The multi-gradation drive circuit according to claim 1, wherein
the current upper limit control circuit further comprises an actual load capacitance calculating circuit that calculates an actual load capacitance for the output voltage V in the drive cycle T in each drive phase, and
the upper limit value of the supply current is the average current Iave in each drive phase multiplied by a predetermined coefficient and the average current Iave is given by Iave=C×V/T.

11. The multi-gradation drive circuit according to claim 10, wherein
the actual load capacitance calculating circuit has:
an ON pixel number calculating circuit that calculates the number of ON pixels in the data of an image to be displayed; and
a table that stores an actual load capacitance corresponding to the calculated number of ON pixels.

12. A cholesteric liquid crystal display device comprising:
a cholesteric liquid crystal panel; and
a multi-gradation drive circuit configured to drive the cholesteric liquid crystal panel in a plurality of drive phases in different drive cycles,
wherein the multi-gradation drive circuit comprises:
a current upper limit control circuit configured to calculate an upper limit of a supply current of a liquid crystal drive power source and outputs an upper limit control signal; and
a supply current limiting circuit configured to limit the supply current of the liquid crystal drive power source to the upper limit value or less specified by the upper limit control signal, wherein
the current upper limit control circuit switches the upper limit control signal to another in accordance with the drive cycle in each drive phase.

13. A multi-gradation driving method of driving a cholesteric liquid crystal display panel in a plurality of drive phases in different cycles, the method comprising:
calculating an upper limit value of a supply current of a power source for driving liquid crystal; and
switching the upper limit value of the supply current of the power source for driving liquid crystal to another in accordance with the drive cycle in each drive phase.
